(19) United States
(12) Patent Application Publication
(10) Pub. No.: US 2012/0006870 A1
(43) Pub. Date: Jan. 12, 2012

(54) Support structure for electronic visual display device

(76) Inventors: Jeff James Proctor, Chandler, AZ (US); David Thomas Huegerich, Scottsdale, AZ (US)

(21) Appl. No.: 12/803,806

(22) Filed: Jul. 7, 2010

(51) Int. Cl. B60R 7/08

(52) U.S. Cl. 224/275

(57) ABSTRACT

A support structure for an electronic visual display device with a pair of vehicle head rest post clamping members, a first and second extension rod, a first and second joint member and an electronic device support plate. The first extension member is L shaped. One end end protrudes into and locks to the headrest post attachment members. The opposite end terminates in a ball shaped member. The second extension rod terminates at each end in a ball shaped members. The support plate has a ball shaped member fixed to its underside. The joint members connect the first and second extension rods to the underside of the support plate. The plate has a clamping member that can retain the visual display device. The joint members clamp on the ball shaped members when joint locking knobs are turned allowing the display to be positioned in a desired location.

### CROSS REFERENCE TO RELATED APPLICATIONS

Not Applicable

### STATEMENT REGARDING FEDERALLY .SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of vehicle accessories and more specifically to a support structure for electronic visual display device to be used in passenger vehicles.

Portable visual electronic display devices have become very popular in recent years. These devices include lap top computers, portable DVD players and graphically enhanced cell phones. Recently, the I Pad product has been introduced by Apple Computer Company. This product is a tablet shaped device that can display everything from the pages of the New York Times to anything that can be downloaded off the Internet, including full length movies. Most of the time, users simply hold the electronic display device in his or her hands and views the displayed material at arms length.
However, a new need has been identified for holding the display device within the interior of a standard motor vehicle so that it may be viewed by either a person sitting in the back seat, or a person sitting in a front seat. To this end, a holding device is needed to position the display device in the desired location.
A number of patented designs have addressed the issue of mounting a display device within a motor vehicle. Pat. No. 6,067,078 shows a design for a pair of display screens that are mounted near a vehicle dashboard. Pat. No. 6,092,705 shows a mounting system that goes between two seats. It also discloses a display that is attached to a head rest by a strap. Other patents that show displays mounted to the floor or center console include:
6,585,155
6,663,155
6,719,343
6,860,414
and 6,899,365.
   Although the above patents describe display attachment means, they have certain deficiencies. The problem with center console mounted designs is that the shape and size of the center console varies from vehicle to vehicle making it hard for the electronic display support device to be universal. The one patent that shows a display attached to the back of a headrest by a strap is limiting in that there is only one location that the display can be viewed in. There is no option to place the display in a desired location and then to lock the support device so that the display stays in the desired location. Additionally, none of the prior art teaches a design for an electronic display support structure that can be easily adjusted to allow viewing by a person sitting in a front seat or a person sitting in a rear seat. Finally, none of the prior art shows that ability for the support structure to be stored, while still attached to a portion of the vehicle, so that it is completely out of the way when not in use.

### BRIEF SUMMARY OF THE INVENTION

The primary object of the invention is a support structure for an electronic visual display device that acts to hold the display device in a desired location within a passenger vehicle.

Another object of the invention is a support structure for an electronic visual display device that can hold the display device so that it can be viewed by a passenger in a rear seat or by a driver in a front seat.

Another object of the invention is a support structure for an electronic visual display device that can be stored while still attached to a portion of the seat of the vehicle so that it is out of the way of the driver or of a passenger when not in use.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a support structure for electronic visual display device comprising: a pair of attachment members each having a vertically disposed aperture that allows the post of a standard passenger vehicle headrest to pass through, each said attachment member being formed of two opposing halves that are held together by screws thereby fixedly attaching said attachment members to said headrest posts, each said attachment member having a horizontally disposed aperture, each said attachment member having a threaded shaft terminating in a locking knob, said threaded shaft capable of penetrating said horizontally disposed aperture, a first rigid extension rod, a second rigid extension rod, a first joint member, a second joint member, a rigid flat electronic device support plate, said first extension member being L shaped, one end of said first extension member end protruding through said horizontally disposed apertures in said headrest post attachment members, the opposite end of said first extension rod terminating in a ball shaped member, said second extension rod terminating at each end in a ball shaped member, said support plate having a ball shaped member fixed to its underside, said support plate being a similar size to the top dimensions of said electronic visual display device, said support plate having at least one standard spring biased clamping member capable of removably retaining at least one side edge of said visual display device, each said joint member comprised of rigid opposing halves, said opposing halves each having ball retaining shapes at each end, said first and second joint members also each having a centrally located threaded post terminating in a knob, said post protruding through a centrally located aperture in one said half of said joint member and threading into a centrally located aperture in the opposing half of said joint member, and said joint members capable of clamping on said ball shaped members when said knobs are turned in a clockwise direction causing said extension rods and said support plate to be locked in a desirable location until unlocked by turning said knobs in a counter clockwise direction.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view view of the invention.

FIG. 2 is a partial side view of the invention.

FIG. 3 is a perspective rear view of the support plate.

FIG. 4 is a perspective view of the invention installed for viewing in the rear seat of a passenger vehicle.

FIG. 5 is a perspective view of the invention installed for viewing in the front seat of a passenger vehicle.

FIG. 6 is a rear view of the support plate being held by the user's hand.

FIG. 7 is a perspective view of the invention in the stored position.

FIG. 8 is a perspective view of an alternate embodiment of the invention.

FIG. 9 is a side view of the alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

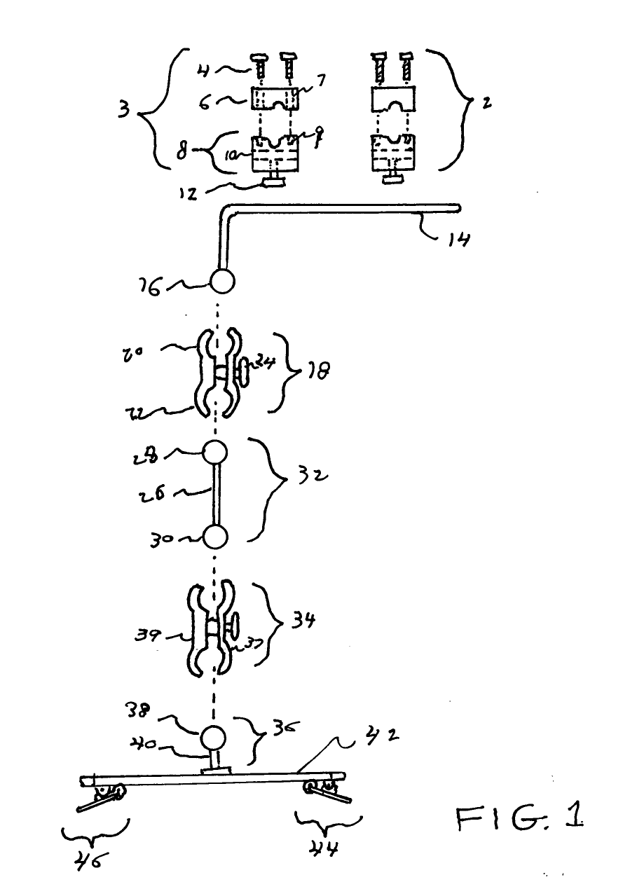

referring now to FIG. 1 we see an exploded view of the components of the present invention. Headrest post clamping members 2, 3 are each comprised of a first half 8 and a second half 6 which can be joined together by threaded screws 6 traveling through apertures 7 and threaded into threaded portions 9. In this way, the clamping members 2, 3 can be attached to headrest posts that do not easily disengage from the top portion of the seat back of a standard vehicle passenger seat. Horizontal apertures 10 allow the long side of L shaped rod 14 to pass through. The rod 14 can then be locked onto the clamping members by turning threaded thumbscrews 12. L shaped arm 14 terminates at its opposite end in a ball shaped member 16. First joint member 18 is capable of retaining ball shaped member 16 on one side and ball shaped member 28 of second extension rod member 32 on the opposite side. Second rod member 32 is comprised of a rigid elongate rod 26 which terminates in ball shaped members 28, 30. Second joint member 34 is capable of retaining ball shaped member 30 on one side and ball shaped member 38 on the opposite side. Ball shaped member is fixedly attached to the underside of electronic visual display holding plate 42 by short shaft 40. Rigid plate 42 includes standard spring biased clamps 44, 46 which are similar to those found on a standard clip board.

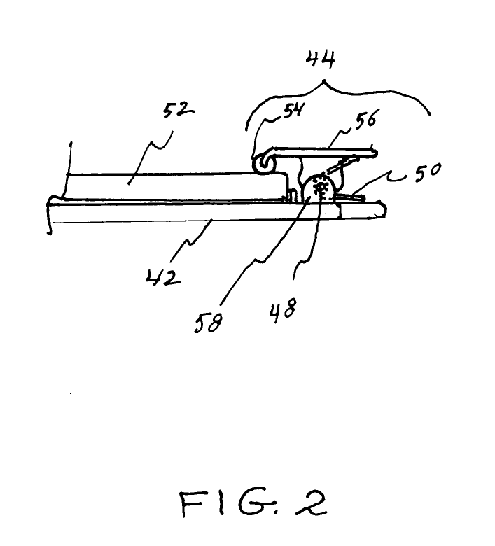

FIG. 2 shows a partial side view of the plate 42 with one of the clamps 44 shown. The top clamp member 56 terminates in a rubber like portion 54 so that the clamp 44 does not scratch or mar the top surface of the electronic visual display device 52 being held. A standard torsion spring 50 causes the top portion 56 of the clamp 44 to produce a continuous clamping effect on device 52 until the user presses on the far end of the clamp member 56 thereby releasing the device 52 from the grip of the clamp 44.

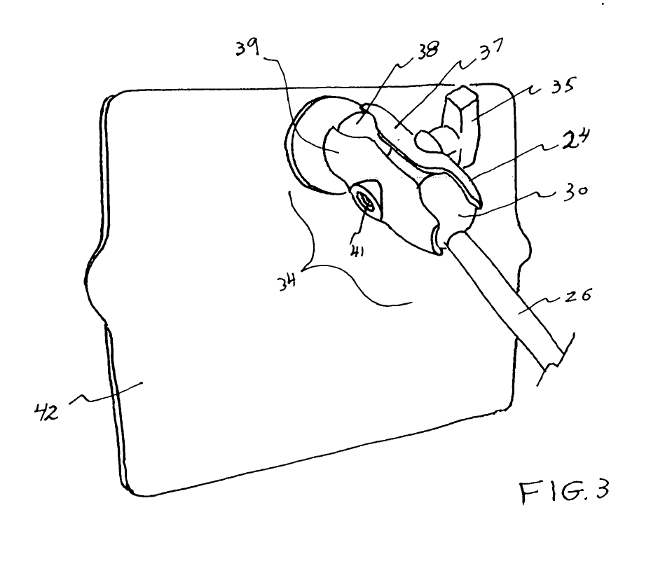

FIG. 3 shows a rear view of the rigid plate 42. Ball member 38 can be clearly seen in the grip of second joint member 34. The joint member 34 terminates on each end in a ball holding shape 24 A knob 35 terminates in a threaded shaft, not shown, which protrudes through an aperture in the central portion of one side 37 of the joint member 34 and into a threaded aperture 41 in the opposite side 39 of joint 34. Joint 32 works in a similar way. This type of joint 34, 32 allows for a wide variety of rotational and angular movement of first support rod 14 and second support rod 26. When the knob 35 is turned clockwise on both joints 32, 34, the support rods 14, 26 and the plate 42 are fixed in place.

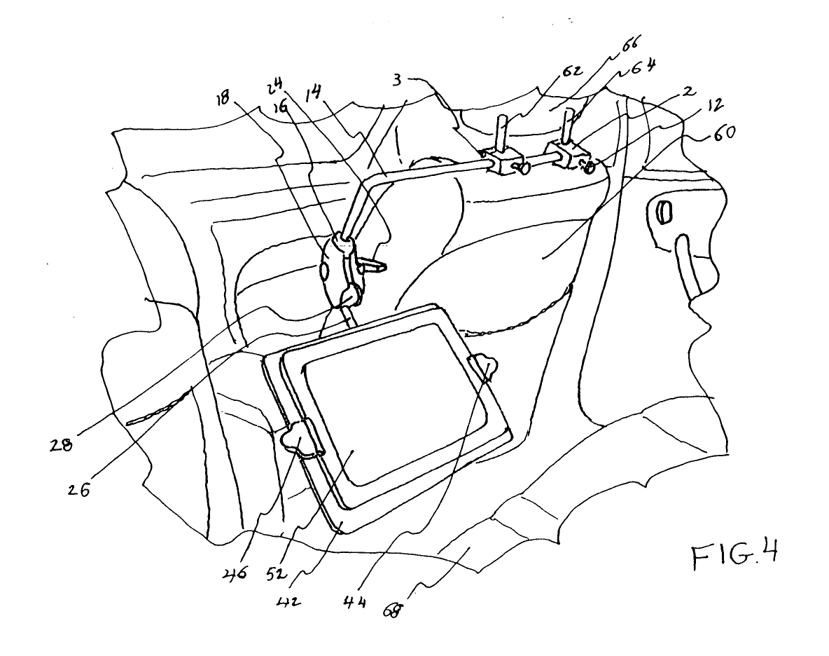

FIG. 4 shows the invention attached to headrest 66 posts 62, 64 of the front passenger seat 60 by clamp members 2, 3. Thumb screws 12 clamp L shaped rigid rod 14 in place. Joint 18 clamps ball member 16 and ball member 28. Electronic visual display device 52 is supported on rigid plate 42 and held in place by spring biased clamps 44, 46. In an alternate embodiment, one of the clamps 46 can be replaced by an inverted L shaped member fixed in place on the top surface of the plate 42 that would retain one side of the electronic device 52 while the clamp 44 on the other side keeps the device 52 from slipping off of the plate 42. The configuration shown in FIG. 4 allows a person or persons in the back seat 68 of the vehicle to view the display of device 52. Additionally, the display can be placed in such a way that the user can easily interact with the display by pressing with his or her fingers on various parts of the touch screen as found on devices such as the I pad. In this way, youngsters in the back seat can play electronic games as well as watch their favorite videos or movies.

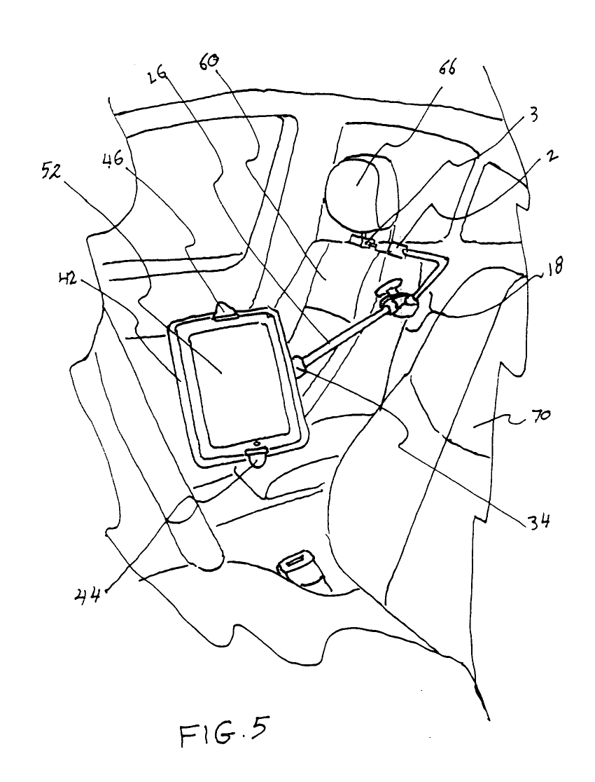

FIG. 5 shows the present invention adjusted for use by a person in the drivers seat 70 of the vehicle. The support structure is fastened to the headrest 66 support posts of passenger seat 60. In this case the display screen of the device 52 has been set in a vertical position which may be ideal for a driver, sitting in drivers seat 70, to read driving instructions that may be displayed on the screen of display device 52.

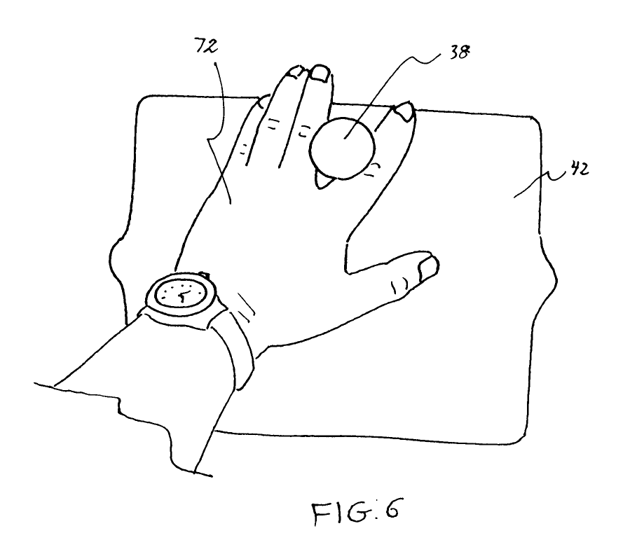

FIG. 6 shows a perspective view of a person holding plate 42, which has been temporarily removed from the rest of the support structure of the present invention, with one hand 72 by retaining ball shape 38 between the fore finger and index finger. In this way, a person can view the display device 52 located on the opposite side with one hand, while having the other hand free to use touch screen features or do other activities.

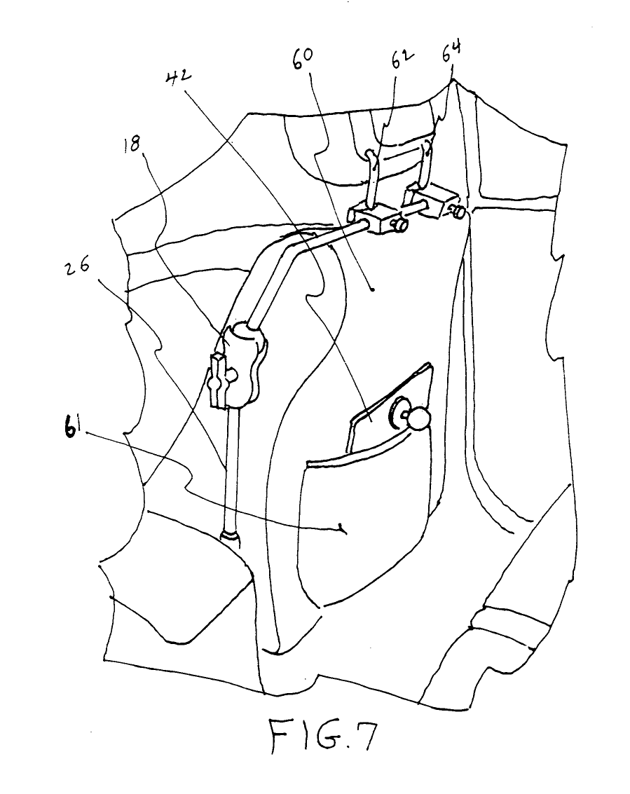

FIG. 7 shows a perspective view of the support structure of the present invention in the stored position. The joint 18 and support arm 26 are nested in close proximity to the side of passenger seat 60. Plate 42 is stored in the back pocket 61 of seat 60. In this way, the support structure of the present invention, while still attached to headrest posts 62, 64 can be stored so that it is out of the way when not in use.

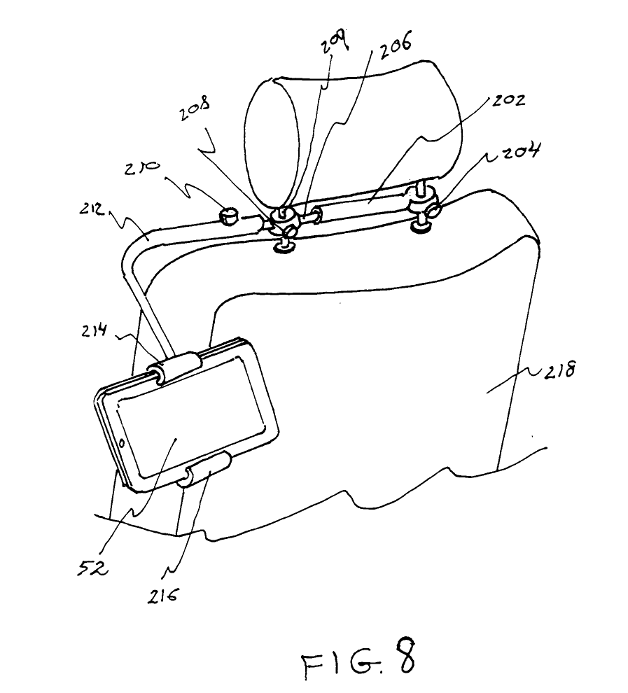

FIG. 8 shows an alternate embodiment of the invention where telescoping tubular members 202, 212 and rod 206 attach to the headrest posts of seat 218 and are locked in place by thumb screws 204, 208. Electronic display device 52 is held by spring biased clips 214, 216. L shaped tubular member 212 is held at the desired angle by thumb screw 210.

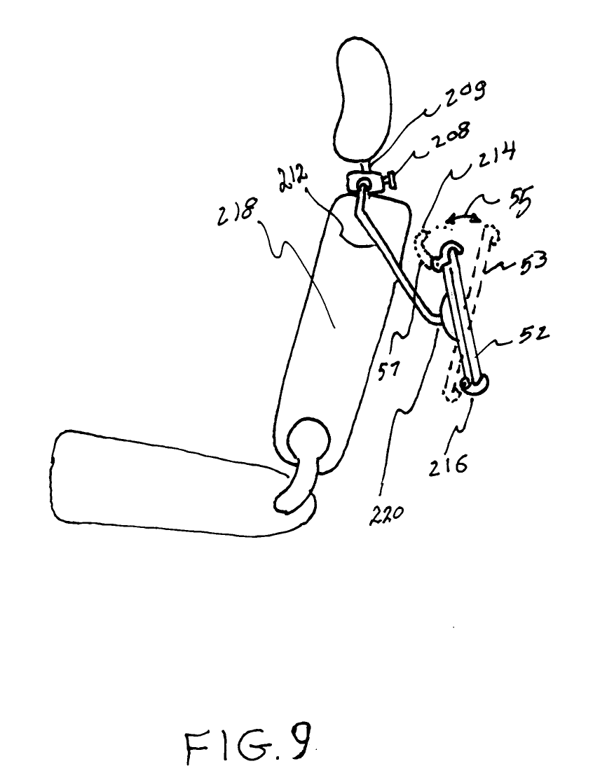

FIG. 9 shows a side view of the alternate embodiment of the present invention attached by thumb screws 208 to the headrest post portion 209 of front seat 218. Support arm 212 terminates at its lower end in a frictional ball joint 220 similar to those found on rear view mirrors used in standard passenger vehicles. The ball joint 220 gives greater adjustability as shown by dotted line 53 and direction arrow 55. Dotted line 57 shows how spring clip 214 can be pulled back to install or remove electronic device 52.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. support structure for electronic visual display device comprising:
a pair of attachment members each having a vertically disposed aperture that allows the post of a standard passenger vehicle head rest to pass through;
each said attachment member having formed of two opposing halves that are held together by screws thereby fixedly attaching said attachment members to said headrest posts;
each said attachment member having a horizontally disposed aperture;
each said attachment member having a threaded shaft terminating in a locking knob;
said threaded shaft capable of penetrating said horizontally disposed aperture;
a first rigid extension rod;
a second rigid extension rod;
a first joint member;
a second joint member;
a rigid flat electronic device support plate;
said first extension member being L shaped;
one end of said first extension member end protruding through said horizontally disposed apertures in said pair of headrest post attachment members;
the opposite end of said first extension rod terminating in a ball shaped member;
said second extension rod terminating at each end in a ball shaped member;
said support plate having a ball shaped member fixed to its underside;
said support plate being a similar size to the top dimensions of said electronic visual display device;
said support plate having at least one standard spring biased clamping member capable of removably retaining at least one side edge of said visual display device;
each said joint member comprised of rigid opposing halves;
said opposing halves each having ball retaining shapes at each end;
said first and second joint members also each having a centrally located threaded post terminating in a knob;
said post protruding through a centrally located aperture in one said half of said joint member and threading into a centrally located aperture in the opposing half of said joint member; and
said joint members capable of clamping on said ball shaped members when said knobs are turned in a clockwise direction causing said extension rods and said support plate to be locked in a desirable location until unlocked by turning said knobs in a counter clockwise direction.

2. A support structure for electronic visual display device as claimed in claim 1 further comprising rubber like covers for the portion of said standard spring biased clamping member that makes contact with the top surface of said electronic visual display device.

3. A support structure for electronic visual display device as claimed in claim 1 wherein an alternate embodiment of said support structure substitutes telescoping rigid extension members locked in place by thumb screws for said first and second extension rods, and substitutes a friction holding ball joint member for said ball shaped member located under said support plate.

4. A support structure for electronic visual display device as claimed in claim 1 wherein said extension rods and said support plate can be positioned by the user to allow an electronic visual display device to be easily viewed by a person sitting in the back seat of a passenger vehicle, or can be positioned to allow the user to view said electronic display device while sitting in the front seat of said vehicle.

5. A support structure for electronic visual display device as claimed in claim 1 wherein the said extension arms of said support device can be positioned by the user to be in close proximity to the side of said passenger seat so that said arms are not in the way when not in use.
